(19) United States
(12) Patent Application Publication
(10) Pub. No.: US 2018/0210384 A1
(43) Pub. Date: Jul. 26, 2018

(54) IMAGE FORMING APPARATUS AND DISPLAY METHOD OF PRINT SETTING SCREEN THEREOF

(71) Applicants: KABUSHIKI KAISHA TOSHIBA, Tokyo (JP); TOSHIBA TEC KABUSHIKI KAISHA, Tokyo (JP)

(72) Inventor: Yuya Oka, Mishima Shizuoka (JP)

(21) Appl. No.: 15/466,042

(22) Filed: Mar. 22, 2017

(30) Foreign Application Priority Data
Jan. 26, 2017 (JP) 2017-012092

(51) Int. Cl. G03G 15/00

(52) U.S. Cl. CPC G03G 15/5016

(57) ABSTRACT

According to one embodiment, a display method of a print setting screen is a display method of a print setting screen of an image forming apparatus including acquiring a status of use of each paper discharging unit from the image forming apparatus, and displaying the print setting screen which accepts setting of each function according to printing, displays the status of use of each paper discharging unit, and accepts an input regarding which paper discharging unit is set as a paper discharging destination.

### CROSS-REFERENCE TO RELATED APPLICATIONS

This application is based upon and claims the benefit of priority from Japanese Patent Application No. 2017-012092, filed Jan. 26, 2017, the entire contents of which are incorporated herein by reference.

### FIELD

Embodiments described herein relate generally to a display technique of a print setting screen.

### BACKGROUND

In the related art, a paper discharging destination can be set using a setting screen of a printing job by a printer driver. However, when the printing job is executed, if a sheet used by another printing job is already in the paper discharging destination, there is a problem that the paper discharging destination of the sheet used by the printing job and the sheet used by another printing job are mixed.

In addition, when the paper discharging destination is not designated in a printing job, the image forming apparatus may detect whether or not the sheet is present on a paper discharging tray at the time of executing the printing job, and determine the paper discharging destination of the sheet based on a detected result. However, such an arrangement is not convenient because a user needs to physically contact the image forming apparatus in order to confirm the paper discharging destination of his or her printing job, or needs to access the UI on the apparatus after the printing job is executed.

### DESCRIPTION OF THE DRAWINGS

FIG. 1 is a view illustrating a configuration of a printer system.

FIG. 2 is a view illustrating a configuration of an image forming apparatus.

FIG. 3 is a flow chart illustrating a printing process executed by the printer system.

FIG. 4 is a view illustrating a print setting screen.

FIG. 5 is a flow chart illustrating a display process of a paper discharging destination executed by the image forming apparatus.

FIG. 6 is a view illustrating a home screen.

### DETAILED DESCRIPTION

In general, according to one embodiment, a display method of a print setting screen is a display method of a print setting screen of an image forming apparatus including acquiring a status of use of each paper discharging unit from the image forming apparatus, and displaying the print setting screen which accepts setting of each function according to printing, displays the status of use of each paper discharging unit, and accepts an input regarding which paper discharging unit is set as a paper discharging destination.

Generally, an image forming apparatus according to an embodiment accepts a transmission request of a status of use of each paper discharging unit from an external terminal which generates a printing job by accepting setting of each function according to printing in a print setting screen, and transmits the status of use of each paper discharging unit with respect to the external terminal.

Hereinafter, embodiments will be described with reference to drawings.

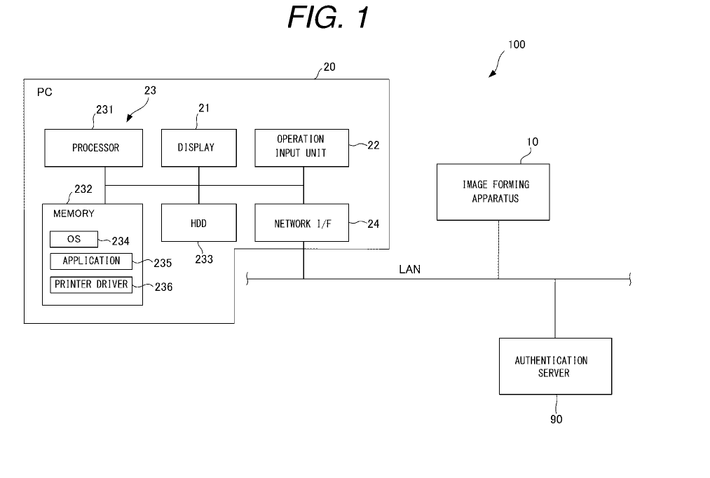

FIG. 1 is a view illustrating a configuration of a printer system 100.

The printer system 100 is provided with a plurality of image forming apparatuses 10, a plurality of personal computers 20 (PC: external terminal), and an authentication sever 90. Moreover, in FIG. 1, only one image forming apparatus 10 and one PC 20 are illustrated. The image forming apparatus 10, the PC 20, and the authentication sever 90 are connected to each other through an electronic communication line such as LAN.

The PC 20 is provided with a display 21, an operation input unit 22, a controller 23, and a network I/F 24. The display 21 displays an image. The operation input unit 22 accepts an operation input of a user. The network I/F 24 transmits and receives information through the LAN. The controller 23 is provided with a processor 231, a memory 232, and a hard disk drive (HDD) 233, and controls the entirety of the PC 20.

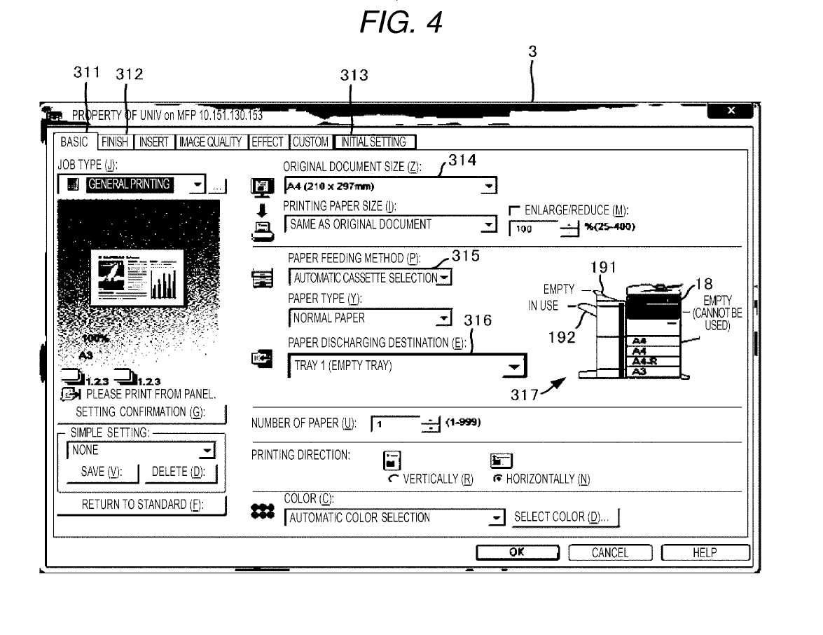

The memory 232 stores an operating system (OS) 234, an application 235, and a printer driver 236 corresponding to the image forming apparatus 10. The processor 231 realizes various functions including displaying, and the like of the print setting screen 3 (FIG. 4) by reading programs 234 to 236, and the like from the memory 232.

The authentication sever 90 accepts a request of authentication of a user from the image forming apparatus 10 and the PC 20, and replies whether or not the authentication is valid.

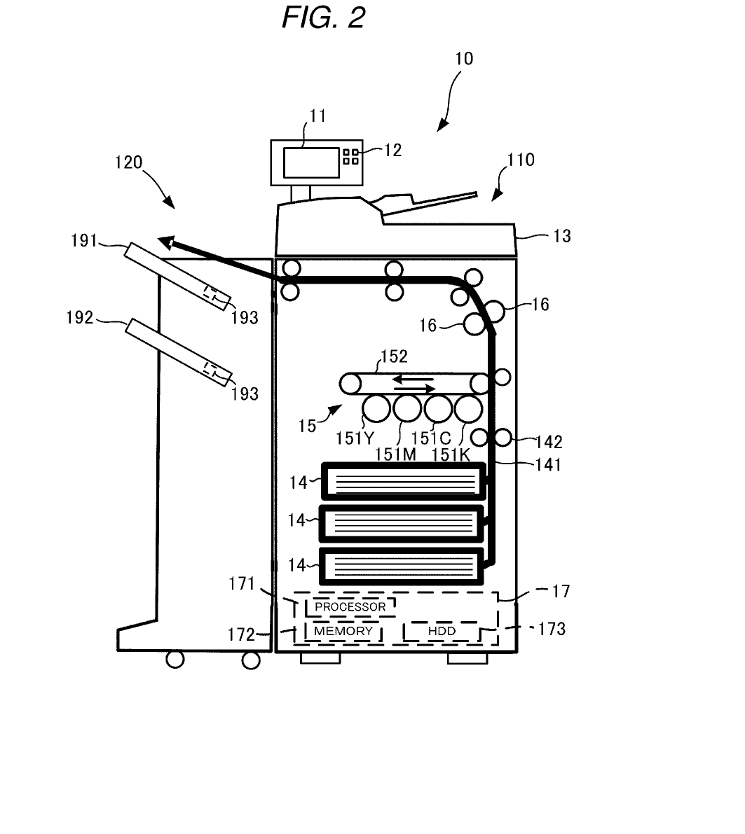

FIG. 2 is a view illustrating a configuration of the image forming apparatus 10.

The image forming apparatus 10 is provided with an apparatus main body 110 and a finisher 120.

The apparatus main body 110 is a multi-function peripheral (MFP) which includes multiple functions such as copying, printing, scanning, FAX, sending of Email, and the like. The image forming apparatus 10 is provided with a display 11, an operation input unit 12, an image reading unit 13, a cassette 14, an image forming unit 15, a fixer 16, a paper discharging unit 18 (FIG. 4), and a controller 17.

The display 11 displays an image. The operation input unit 12 receives an operation input of a user. The image reading unit 13 reads an image on a sheet. The sheet placed in the cassette 14 is transported to a transportation passage 141. The transportation passage 141 reaches the finisher 120 from the cassette 14. Each part of the transportation passage 141 is provided with a transportation roller 142 which transports the sheet to a downstream.

In the image forming unit 15, a laser optical system which is not illustrated exposes photosensitive bodies 151Y to 151K, and forms latent images on the photosensitive bodies 151Y to 151K. A developer which is not illustrated develops the latent image on the photosensitive body 151Y using a toner of Y, and forms a toner image of the Y on the photosensitive body 151Y. On the photosensitive bodies 151M to 151K, toner images of M to K are formed in the same manner. The photosensitive bodies 151Y to 151K repeatedly transfer the toner images of the Y to K on a transfer belt 152, and form one toner image having multiple colors on the transfer belt 152. The transfer belt 152 transfers the toner image on the sheet. The fixer 16 fixes the toner images on the sheet by heating the sheet.

A branch passage which is not illustrated reaching the paper discharging unit 18 is provided in the transportation passage 141 from the fixer 16 reaching the finisher 120. The paper discharging unit 18 is in a trunk of the apparatus main body 110. The apparatus main body 110 is capable of discharging the sheet passing through the fixer 16 to the paper discharging unit 18 inside the trunk. A remaining paper sensor not illustrated, which detects whether or not the sheet is present on the paper discharging unit 18, is provided in the paper discharging unit 18. In the paper discharging unit 18, a full sensor which detects whether or not the paper discharging unit 18 is full with the sheets thereon may be provided.

The controller 17 is provided with a processor 171, a memory 172, and a HDD 173, and controls the entirety of the image forming apparatus 10.

The finisher 120 discharges the sheet printed by executing a printing job with the apparatus main body 110 to paper discharging units 191 and 192 of the paper discharging destination set by the printing job. The finisher 120 detects whether or not the sheet is present on the paper discharging units 191 and 192 using the remaining paper sensor 193, and transmits a detected result to the controller 17 of the apparatus main body 110. The finisher 120 is provided with the full sensor which detects whether or not the sheets are full on the paper discharging units 191 to 193 are full with the sheets thereon, and may transmit the detected result using the full sensor to the controller 17.

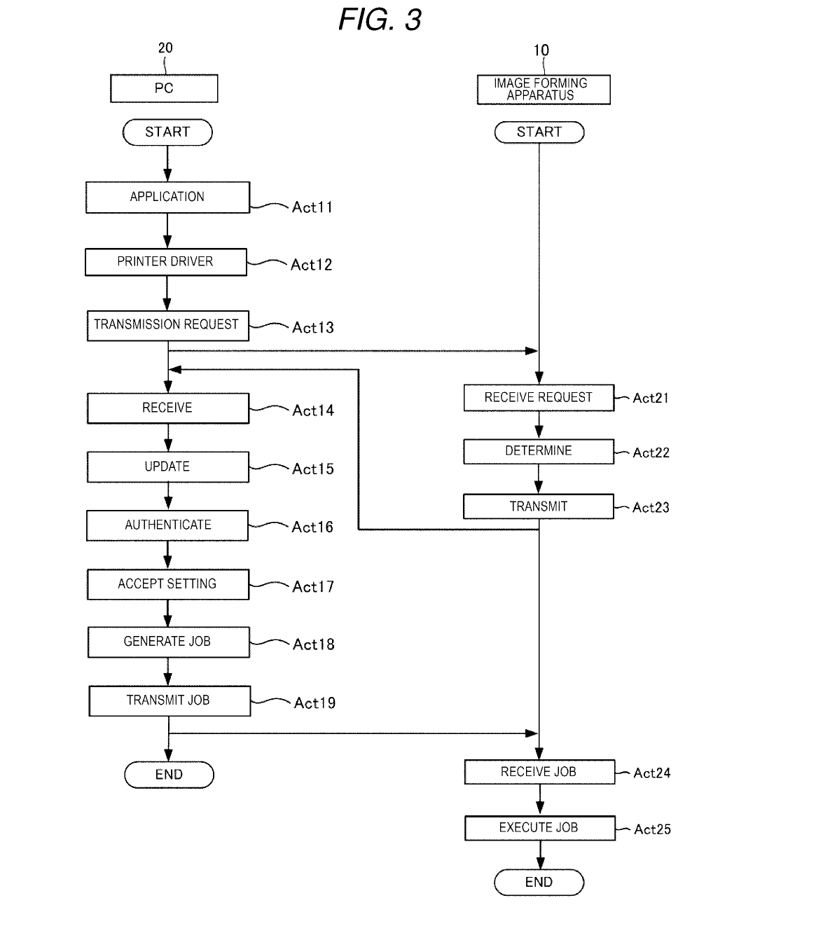

Hereinafter, a printing process by the printer system 100 will be described with reference to a flow chart of FIG. 3.

The controller 23 of the PC 20 displays a print setting screen of the application 235 on the display 21 (Act 11). In the print setting screen of the application 235, a user selects the image forming apparatus 10 used for printing, and presses a property button. Thus, the PC 20 displays the print setting screen 3 (FIG. 4) of the printer driver 236 specific in the image forming apparatus 10 on the display 21 (Act 12). The print setting screen 3 will be described later.

Subsequently, the PC 20 performs a transmission request of a status of use of the paper discharging units 18, 191, and 192 on the image forming apparatus 10 and a transmission request of option information of the image forming apparatus 10 (Act 13). The option information indicates information of a staple function, a hole punch function, and the like included in the paper discharging units 18, 191, and 192 of the image forming apparatus 10.

The controller 17 of the image forming apparatus 10 determines the status of use of the paper discharging units 18, 191, and 192 (Act 22) when accepting the transmission request (Act 21). The image forming apparatus 10 determines the status of use of the paper discharging units 18, 191, and 192 from the presence or absence of the sheet on the paper discharging units 18, 191, and 192 detected by the remaining paper sensor 193, and setting of the paper discharging destination of the printing job which is not executed.

The status of use of the paper discharging units 18, 191, and 192 indicates information indicating whether or not there is a possibility that the sheets are present in the paper discharging units 18, 191, and 192, that is, indicating that the paper discharging units 18, 191, and 192 are in use, when the image forming apparatus 10 executes printing job to be received from the PC 20 from now on. In the embodiment, the image forming apparatus 10 detects that the sheets are not present in the paper discharging units 18, 191, and 192, and the paper discharging destination of the printing job which is not executed is set at the paper discharging unit 192. Here, the image forming apparatus 10 determines that the paper discharging units 18 and 191 are empty (not used) and the paper discharging unit 192 is in use.

The image forming apparatus 10 transmits the status of use of the paper discharging units 18, 191, and 192 and the option information of the image forming apparatus 10 to the PC 20 (Act 23).

The PC 20 receives the status of use of the paper discharging units 18, 191, and 192 and the option information of the image forming apparatus 10 (Act 14).

FIG. 4 is a view illustrating the print setting screen 3. Hereinafter, the print setting screen 3 is described as a setting screen 3 in some times.

The setting screen 3 accepts setting of each function according to printing of the image forming apparatus 10. The PC 20 displays the setting screen 3 in accordance with tabs 311 to 313 when accepting selection of the tabs 311 to 313 on a top of the setting screen 3. FIG. 4 illustrates the setting screen 3 of the basic tab 311. There are a setting space 314 of a sheet size or the setting space 315 of a paper feeding cassette, and the setting space 316 of the paper discharging destination in the setting screen 3 of the basic tab 311. The setting spaces 314 to 316 are constituted by a drop down list. The PC 20 lists up options when the setting spaces 314 to 316 are selected.

An image 317 indicating the status of use of the paper discharging units 18, 191, and 192 of the image forming apparatus 10 is positioned at a right side of the setting space 316. The image 317 indicates an exterior of the image forming apparatus 10 and indicates the paper discharging units 18, 191, and 192.

If the PC 20 receives the status of use of the paper discharging units 18, 191, and 192 (Act 14), the PC updates the image 317 based on the received status of use of the paper discharging units 18, 191, and 192, and corresponds the status of use of the paper discharging units 18, 191, and 192 to the paper discharging units 18, 191, and 192 in the image 317 so as to be displayed (Act 15). In the embodiment, in the PC 20, a character of “empty” is corresponded to the paper discharging units 18 and 191, and a character of “in use” is corresponded to the paper discharging unit 192. “Empty” means that the tray is not in use but it is available for use. Additional words other than “empty” can be used to achieve the same meaning.

In addition, the PC 20 displays the paper discharging units 18, 191, and 192 as options if the setting space 316 of the paper discharging destination is selected. At this time, after receiving the status of use of the paper discharging units 18, 191, and 192 (Act 14), the PC 20 includes the status of use of the paper discharging units 18, 191, and 192 written as the paper discharging units 18, 191, and 192 as an option. In the embodiment, the PC 20 includes a character of an “empty tray” written as the paper discharging units 18 and 191 as an option, and includes a character of the paper discharging unit 192 written as a “tray in use” as an option. Moreover, a “tray 1” of FIG. 4 indicates the paper discharging unit 191.

The PC 20 displays the setting screen 3 accepting an input of a user's name and a password when selection of an initial setting tab 313 is accepted. The PC 20 requests authentication of a user from the authentication sever 90 based on the accepted user's name and the pas sword which are input. In the embodiment, the PC 20 accepts a reply of validity of the user from the authentication sever 90 (Act 16).

The PC 20 accepts setting of the printing job in the setting screen 3 of each of the tabs 311 and 312 (Act 17).

If the PC 20 accepts the selection of the finish tab 312, the PC displays the setting screen 3 which accepts setting of an option function of the image forming apparatus 10. The PC 20 accepts setting of a double-side printing function or a Nin 1 printing function, a staple function, a hole punch function, and the like using the setting screen 3 of the option function.

In addition, the PC 20 accepts setting of a sheet size or a paper feeding cassette, and the paper discharging destination using the basic tab 311. At this time, the PC 20 determines whether or not a use of the paper discharging units 18, 191, and 192 is inhibited, and displays whether or not the use of the paper discharging units 18, 191, and 192 is inhibited, on the basis of setting of the option function being accepted and the option information being received, in the image 317 and the setting space 316 of the paper discharging destination.

In the embodiment, the PC 20 accepts the staple function as setting of the option function. In addition, in the option information which the PC 20 receives, there is no staple function in the paper discharging unit 18 in the trunk of the image forming apparatus 10. Since the paper discharging unit 18 does not include the staple function, the PC 20 determines that the use of the paper discharging unit 18 is inhibited.

Here, in the PC 20, the paper discharging unit 18 in the trunk of the image forming apparatus 10 is corresponded to a character of “cannot be used” in the image 317. The PC 20 displays the paper discharging unit 18 with black which is different from a color other than that of the paper discharging unit 18, and indicates that the use of the paper discharging unit 18 is inhibited in the image 317. Moreover, the color of the paper discharging unit 18 described above may be any color other than black as long as the color thereof can be identified from the color other than that of the paper discharging unit 18.

In addition, the PC 20 displays the paper discharging unit 18 as not being selectable when the setting space 316 of the paper discharging destination is selected.

The PC 20 generates the printing job based on the setting accepted using the setting screen 3 (Act 18). The printing job includes information of the user.

The PC 20 transmits the printing job to the image forming apparatus 10 (Act 19).

The image forming apparatus 10 receives the printing job (Act 24), and executes the printing job (Act 25). The image forming apparatus 10 discharges the printed sheet to the paper discharging destination set in the printing job.

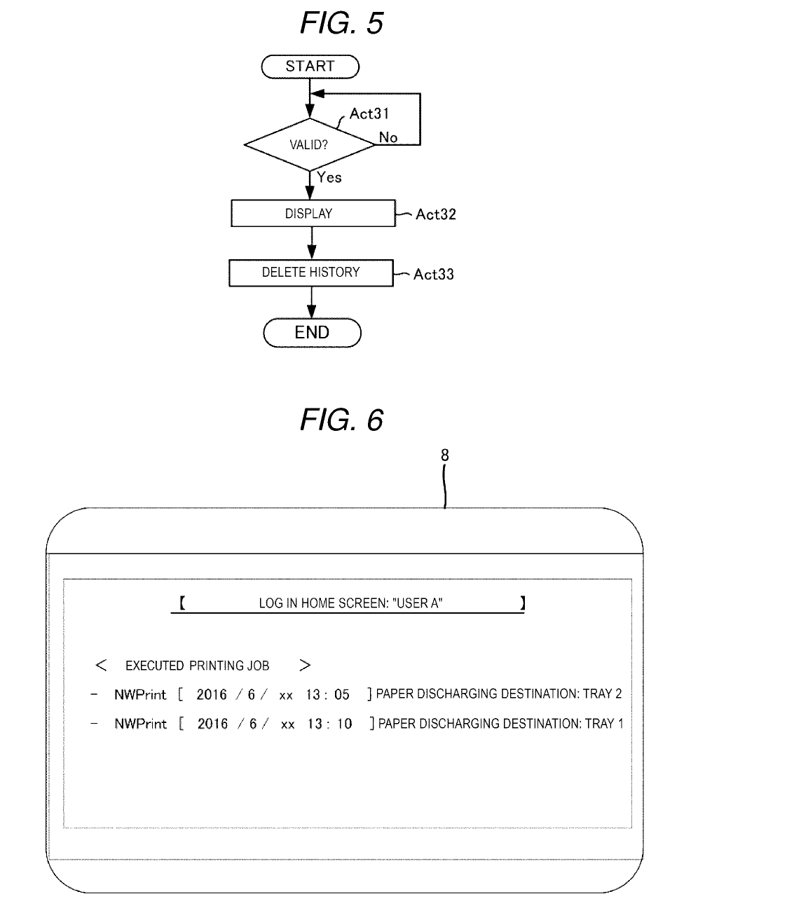

Hereinafter, the display process of the paper discharging destination using the image forming apparatus 10 when the user logs in the image forming apparatus 10 will be described with reference to a flow chart of FIG. 5.

The image forming apparatus 10 accepts authentication of the user and requests authentication from the authentication sever 90. The image forming apparatus 10 accepts a reply of validity of the user from the authentication sever 90 (YES in Act 31).

The image forming apparatus 10 stores a display history with respect to the user of the printing job which is already executed in the memory 232. The display history is constituted by data of the printing job which is not displayed with respect to the user, that is, a printing job name of the printing job, a date when the printing job is executed, and the paper discharging destination.

FIG. 6 is a view illustrating a home screen 8.

The image forming apparatus 10 displays the home screen 8 when the user is determined to be valid (Act 32). The home screen 8 indicates a screen displayed right after the user logs in the image forming apparatus 10. The image forming apparatus 10 lists up the printing job name of the printing job which is not displayed but is already executed with respect to the user, the date when the printing job is executed, and the paper discharging destination on the home screen 8.

The image forming apparatus 10 deletes the data of the printing job which is already displayed from the display history (Act 33). Accordingly, when the user accesses the home screen 8, the paper discharging destination of the printing job which is already executed is displayed to the user only once.

### Modification Example

In the embodiment described above, the image forming apparatus 10 determines that the paper discharging units 18, 191, and 192 is in use itself and replies the determined result to the PC 20, when receiving the transmission request of the status of use of the paper discharging units 18, 191, and 192. However, the image forming apparatus 10 may transmits the presence or absence of the sheets on the paper discharging units 18, 191, and 192, or the setting of the paper discharging destination of the printing job which is not executed of the image forming apparatus 10 as it is to the PC 20, when receiving the transmission request. Also, the PC 20 may determine whether or not the paper discharging units 18, 191, and 192 are in use when the printing job is transmitted to the image forming apparatus 10.

The PC 20 may receive whether or not the paper discharging units 18, 191, and 192 are full from the image forming apparatus 10. The PC 20 determines that a use of the full paper discharging units 18, 191, and 192 is inhibited in the image 317, and may display that the full paper discharging units 18, 191, and 192 cannot be used. The PC 20 displays that the paper discharging units 18, 191, and 192 are full in the setting space 316 of the paper discharging destination, and may display that the full paper discharging units 18, 191, and 192 cannot be selected.

As described above, according to a technique described in this specification, a display technique of the print setting screen with the advantages of employing an intelligent, interactive display can be provided.

While certain embodiments have been described, these embodiments have been presented by way of example only, and are not intended to limit the scope of the inventions. Indeed, the novel apparatus, methods and system described herein may be embodied in a variety of other forms; furthermore, various omissions, substitutions and changes in the form of the apparatus, methods and system described herein may be made without departing from the spirit of the inventions. The accompanying claims and their equivalents are intended to cover such forms or modifications as would fall within the scope and spirit of the inventions.

What is claimed is:

1. A display method of a print setting screen of an image forming apparatus, comprising:
acquiring a status of use of each paper discharging unit from the image forming apparatus, and
displaying the print setting screen which accepts setting of each function according to printing, displays the status of use of each paper discharging unit, and accepts an input regarding which paper discharging unit is set as a paper discharging destination.

2. The method according to claim 1, further comprising:
displaying that the paper discharging unit of the paper discharging destination set by the printing job which is not executed is in use.

3. The method according to claim 1, further comprising:
displaying that the paper discharging unit where the sheet is included is in use.

4. The method according to claim 1, further comprising:
acquiring option information of the image forming apparatus is acquired from the image forming apparatus; and
displaying in the setting screen the paper discharging unit which is inhibited from being used on the basis of the accepted setting of the printing job and the option information.

5. The method according to claim 4,
wherein the option information of the image forming apparatus comprises at least one of double sided printing, sheet size, and a staple function.

6. The method according to claim 1, further comprising:
displaying a selection screen of each paper discharging unit as the paper discharging destination in the print setting screen; and
displaying the status of use of each paper discharging unit in the selection screen.

7. The method according to claim 1, further comprising:
displaying in the print setting screen an image of the image forming apparatus and the status of use corresponding with each paper discharging unit of the image forming apparatus.

8. The method according to claim 7, further comprising:
acquiring option information of the image forming apparatus from the image forming apparatus;
determining in the setting screen the paper discharging unit which is inhibited from being used on a basis of an accepted setting of the printing job and the option information; and
displaying the inhibition of use of the paper discharging unit.

9. The method according to claim 1,
wherein the status of use of each paper discharging unit is one of “empty” or “in use”.

10. The method according to claim 1, further comprising:
acquiring a status of at least two paper discharging units.

11. The method according to claim 1, further comprising:
acquiring a status of at least three paper discharging units.

12. An image forming apparatus, comprising:
an input component configured to accept a transmission request of a status of use of each paper discharging unit from an external terminal which generates a printing job by accepting setting of each function according to printing in a print setting screen; and
an output component configured to transmit the status of use of each paper discharging unit with respect to the external terminal.

13. The apparatus according to claim 12, further comprising:
a controller configured to determine the status of use of each paper discharging unit on a basis of whether or not a sheet is present on each paper discharging unit and setting of the paper discharging destination of a printing job, which is not executed; and
the output component further configured to transmit the status of use with respect to the external terminal.

14. The apparatus according to claim 12, further comprising:
after the input component is further configured to accept the printing job comprising information of a user from the external terminal;
an authentication component configured to authenticate the user so that validity is determined; and
a display configured to display the paper discharging unit of the paper discharging destination at the time of executing the printing job.

15. The apparatus according to claim 13, further comprising:
a sensor to determine whether or not a sheet is present on each paper discharging unit.

16. The apparatus according to claim 12, comprising at least two paper discharging units.

17. The apparatus according to claim 12, comprising at least three paper discharging units.

18. The apparatus according to claim 12, wherein
the output component is configured to transmit the status of use of each paper discharging unit as “empty” or “in use”.

19. A personal computer in communication with an image forming apparatus, comprising:
an output component configured to send a transmission request of a status of use of each paper discharging unit for a printing job by sending a setting of each function according to printing in a print setting screen; and
an input component configured to receive the status of use of each paper discharging unit of the image forming apparatus.

20. The personal computer according to claim 19, further comprising:
a controller configured to determine the status of use of each paper discharging unit on a basis of whether or not a sheet is present on each paper discharging unit and setting of the paper discharging destination of a printing job, which is not executed.
